(19) United States
(12) Patent Application Publication
(10) Pub. No.: US 2009/0325558 A1
(43) Pub. Date: Dec. 31, 2009

(54) METHOD OF COMPILING A LIST OF IDENTIFIERS ASSOCIATED WITH A MOBILE DEVICE USER

(75) Inventors: Andrew Paul PRIDMORE, Hampshire (UK); Paul Maxwell MARTIN, Hampshire (UK); Anthony Richard TIMSON, Hampshire (UK)

Correspondence Address: NIXON PEABODY, LLP, 401 9TH STREET, NW, SUITE 900, WASHINGTON, DC, 20004-2128, US

(73) Assignee: M.M.I. RESEARCH LIMITED, Hampshire (UK)

(21) Appl. No.: 11/996,224

(22) PCT Filed: Jul. 17, 2006
(86) PCT No.: PCT/GB06/02641

§ 371 Date: Jan. 18, 2008

(30) Foreign Application Priority Data
Jul. 22, 2005 (GB) 0515123.8

(51) Int. Cl. H04M 3/42

(52) U.S. Cl. 455/415

(57) ABSTRACT

A method of compiling a list of IDs associated with a mobile device user, the method including the steps of: a) identifying and recording a first subscriber ID and a first device ID; b) using one of the first IDs as a key to identify one or more second IDs, each of which has been associated with the key in a mobile device communication; and c) recording the second ID(s).

The present invention relates to a method and apparatus for compiling a list of IDs associated with a mobile device user.

A conventional mobile phone user possesses both hardware (the mobile station or MS) and an identity module (the SIM card). A SIM card must be inserted in the MS before outgoing calls (except emergency calls) can be made. The SIM card carries an identity known as the International Mobile Subscriber Identity (IMSI) which is the identity related to the “phone number” (more accurately MSISDN). Therefore whenever a MSISDN number is dialled, the network searches for the MS that has the related IMSI in order to route the call. The IMSI can be inserted in any compatible phone and the call is then routed to that device.

The mobile phone network also uses a separate identity, the International Mobile Equipment Identity (IMEI). This is unique to each MS and is set on manufacture. The IMEI therefore uniquely identifies the particular MS.

The operator of an identity tracker typically wishes to track the activities of a particular person. This person may operate multiple MSs and SIM cards, regularly swapping SIM cards between MSs. Therefore to track the activities of such a person, the operator must:
1 obtain all IMSIs and IMEIs operated by that person over a particular time interval;

and
2 track the pairing of IMSIs and IMEIs over a particular time interval.

A first aspect of the present invention provides a method of compiling a list of IDs associated with a mobile device user, the method including the steps of:
identifying and recording a first subscriber ID and a first device ID;
using one of the first IDs as a key to identify one or more second IDs, each of which has been associated with the key in a mobile device communication; and
recording the second ID(s).

A second aspect of the invention provides apparatus for compiling a list of IDs associated with a mobile device user, the apparatus including:
a storage device for recording a first subscriber ID and a first device ID; and
a processor configured to use one of the first IDs as a key to identify one or more second IDs, each of which has been associated with the key in a mobile device communication.

Embodiments of the present invention will now be described with reference to the accompanying drawings, in which:

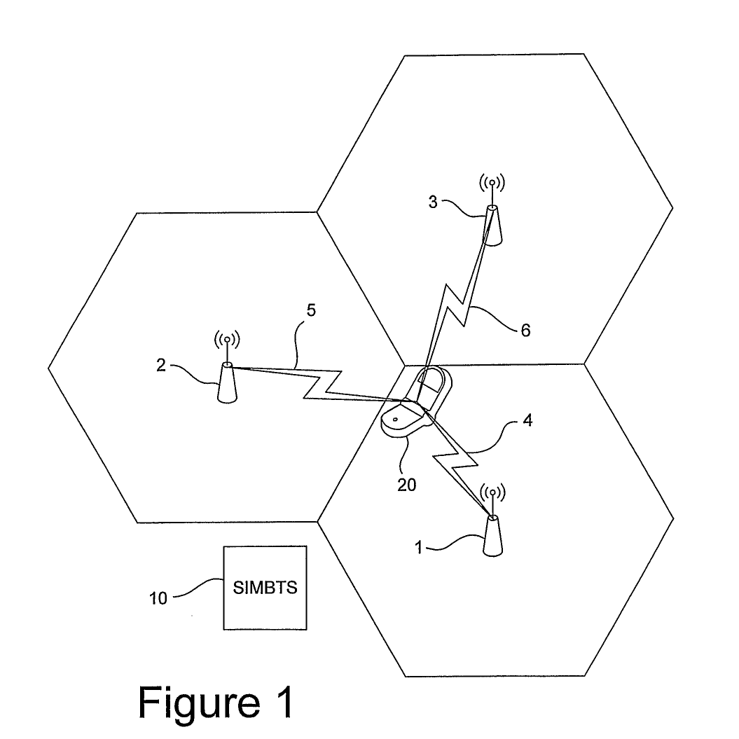

FIG. 1 is a schematic diagram showing a mobile station (MS) receiving multiple Broadcast Channels (BCH);

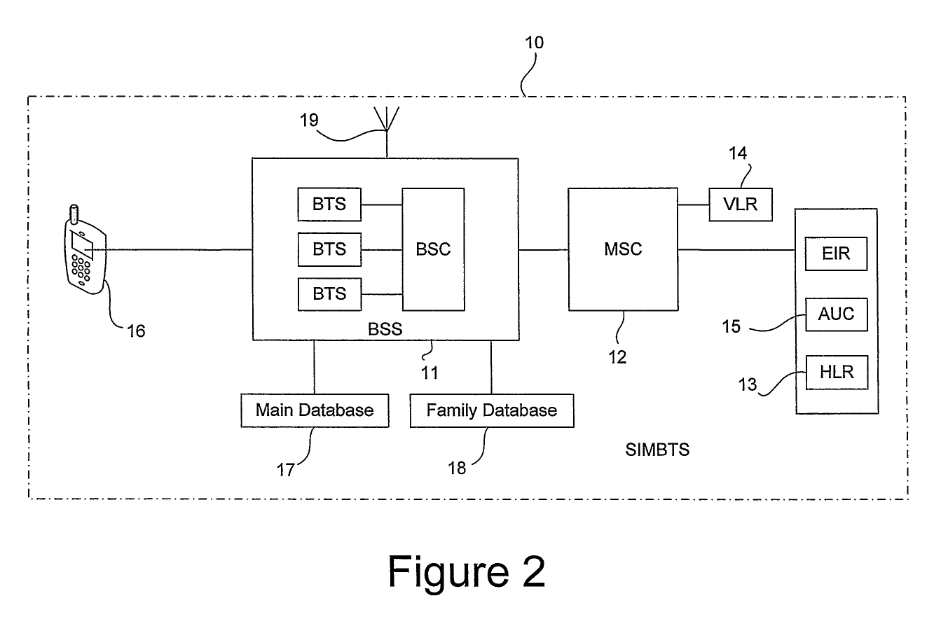

FIG. 2 shows a SIMBTS and test mobile;

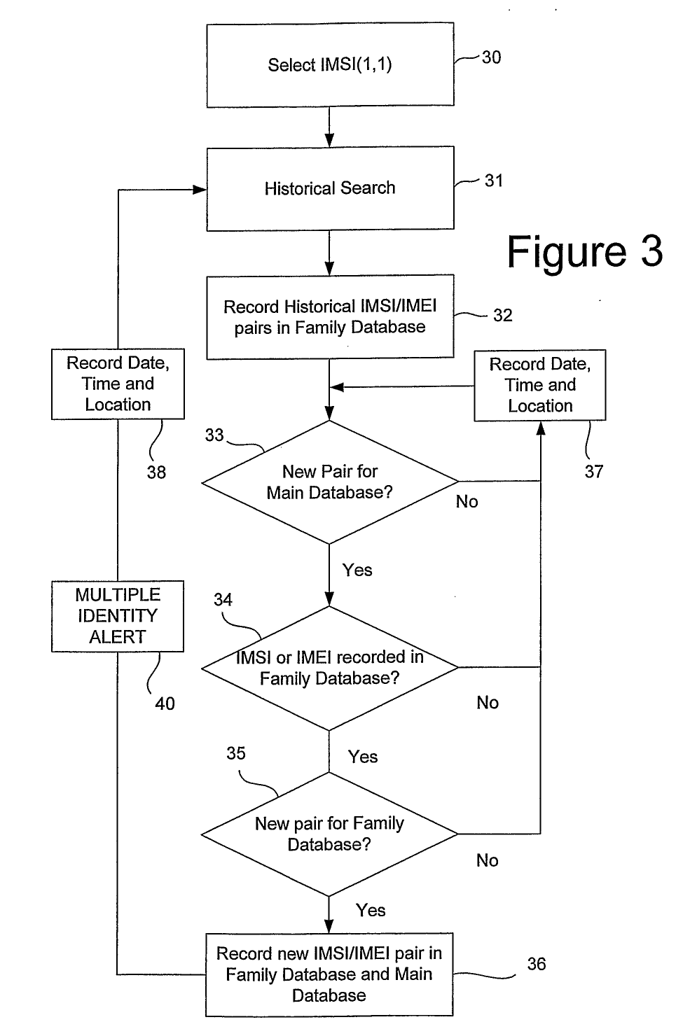

FIG. 3 shows a method of compiling a list of IDs associated with a mobile device user;

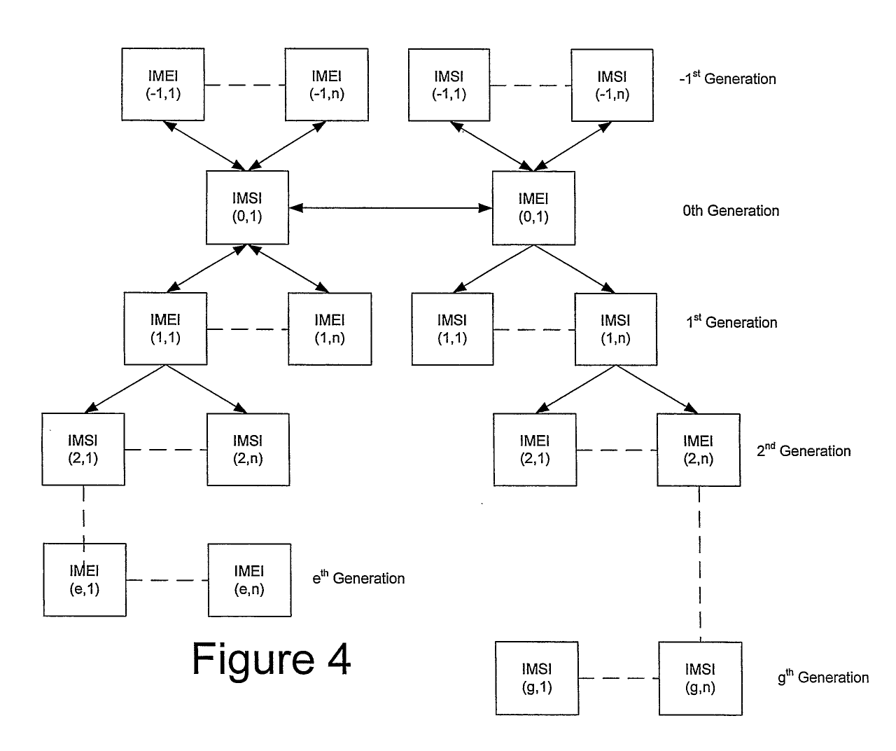

FIG. 4 shows the structure of the Family Database; and

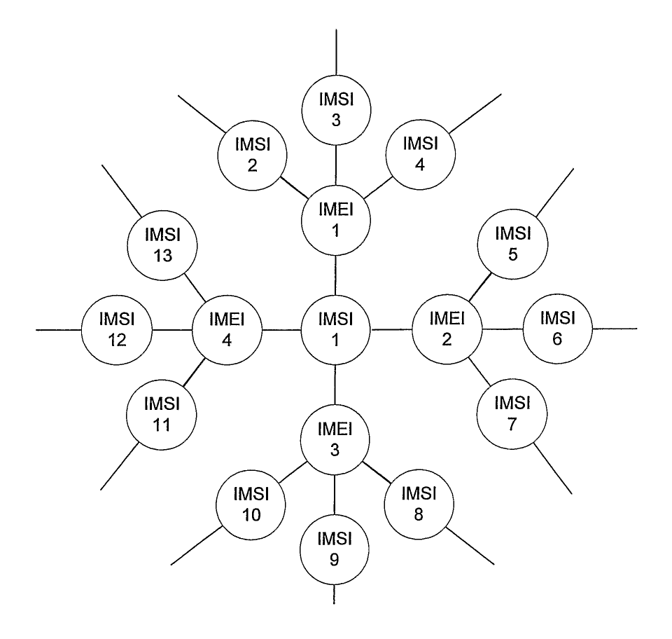

FIG. 5 shows a network of IMSI/IMEI pairs.

### BACKGROUND

Conventional GSM mobiles use two algorithms known as the C1 and C2 algorithms to decide on which base station (BTS) to camp. Camp is here defined as the BTS which is transmitting broadcast information to which the mobile is listening. This situation is illustrated in FIG. 1 where three BTSs 1-3 are broadcasting on three unique BTS Broadcast Channels (BCH) 4-6. On moving into the vicinity of the three BTSs, a Mobile Station (MS) 20 evaluates on which BTS to camp. Once the camping decision is made, the mobile moves to receive the BCH from the chosen BTS as per the GSM specifications.

The mobile 20 may choose to actively register with the network through the chosen BTS if a Location Area boundary is crossed or if a network defined time has elapsed. The mobile 20 receives a list (the Broadcast Allocation or BA list) of neighbouring BTS broadcast frequencies from the camped BTS and is mandated to scan these broadcast channels for signal parameters. As a mobile moves, it calculates the C1 and C2 parameters based on the received signal strengths of the current BTS and the neighbouring BTSs contained in the BA list. If a hysteresis threshold is crossed, then the mobile will camp onto the new BTS with higher signal strength and/or signal quality (note this simplifies the actual process involved).

Taking the case of a single Location Area within an area of good GSM coverage; this Location Area will be served by several BTSs. Now considering a particular mobile phone; this will be camped on one of the BTSs serving the target area. The actual BTS on which the mobile is camped will depend on three parameters:
a) The received signal strengths (in the standards, RLA_C) of the serving BTSs at the location of the mobile phone.
b) The setting of the BCH parameters used by the C1 and C2 algorithms, including:
   RXLEV_ACCESS_MIN
   MS_TXPWR_MAX_CCH
   CELL_RESELECT_OFFSET (CRO)
   TEMPORARY OFFSET
   PENALTY_TIME
   CELL_RESELECT_HYSTERESIS (CRH)
c) The history of the location of the mobile phone, for example if the phone was camped on BTS 1 and has moved to a location where the signal strength from BTS 2 is greater (but less than CRH) then the phone will remain camped on BTS 1.

Due to point c), mobile phones present in a particular region of interest will be camped on many and perhaps all of the BTSs serving the region. Note also that there is a further complication which is that the BTSs serving a particular location will have differing BA lists. The consequence of this is that the mobile phones in a particular location will potentially be scanning different sets of broadcast frequencies. Although the BA lists are likely to overlap substantially, there will be differences.

A Separately Introduced Multiple Base Station (SIMBTS) 10 is shown in FIG. 1, and in detail in FIG. 2. The principle aim of the SIMBTS is to interrogate all GSM mobile phones in a particular area in order to acquire their International Mobile Subscriber Identity (IMSI), International Mobile Equipment Identity (IMEI) and Temporary Mobile Subscriber Identity (TMSI) identities.

The SIMBTS 10 performs a subset of the functions of a complete GSM network, ranging from air interface protocol exchanges in the Base Station System (BSS) 11 to the switch oriented functions at the Mobile Switching Centre (MSC) 12 and security and authentication functions of the Home Location Register (HLR) 13, Visitor Location Register (VLR) 14 and Authentication Centre (AUC) 15.

Key to the practical application of the SIMBTS 10 is the speed of acquisition of the data. This enables the SIMBTS operator to spend the minimum amount of time in a particular area, speeding up operation and minimising the personal risk to the operator.

### IMSI/IMEI Acquisition

The SIMBTS 10 bypasses conventional GSM procedures to achieve the objective of obtaining all mobile identities from phones served by a particular operator. To do this, the following steps are performed:
1. The SIMBTS 10 forces a test mobile phone 16 (eg Ericsson TEMS) to obtain broadcast allocation lists (BA lists) from all BTSs serving a particular location and for all operators. The procedure is to:
   a) go to the BTS with the highest signal strength (BTS 1);
   b) obtain its BA list and cell parameters controlling the C1 and C2 algorithms;
   c) force the test mobile 16 to go to the first BTS in the BA list (BTS2) and obtain its BA list;
   d) continue until BA lists from a certain number of BTSs are obtained or, alternatively and in an enhanced algorithm, all BTSs with signal strengths within CRH dB of BTS1 are obtained.
2. Compute the list of common BTSs (union) from all received BA lists passing the criterion mentioned in 1d) above (these constitute the complete set on which all mobiles in the area around the test mobile 16 are going to be camped from all network operators).
3. Emulate all BTSs in the common BTS (BA) list and obtain the mobile identities. Note that there are two possible methods to emulate BTSs: a) one at a time, and advantageously via an autonomous autorotation process; or, b) a considerable enhancement over a) is to emulate several BTSs simultaneously. The key advantage is the decreased time required to gain the IMSIs and IMEIs due to the parallel operation. This depends on the capabilities of the hardware and management software which must be carefully designed to avoid interference issues.

Note that to convey its identities, the mobile must perform a “location update”. The mechanism for this is for a BTS in the current BA list received by the mobile, to be of higher than CRH signal strength than the current BTS. The mobile will then camp on the new BTS and, if the location area code (LAC) is different, it will perform a location update, thereby triggering an identity exchange.

The important point here is that the emulation of BTSs and acquisition of mobile identities can be automated. No operator interaction is required other than to start the process. Consequently the process can be high speed. Typically the location of the operators of this equipment is “difficult” and the key driver is to minimise the time to complete the operation.

The process in point a) above is illustrated in the table of operation given in Table 1.

TABLE 1
Sequential Process for SIMBTS MS identity acquisition

| Step | Action | Result |
|---|---|---|
| 1 | Use test phone 16 to perform steps 1 and 2 | List of BTSs |
| | above to obtain list of BTSs with signal | Operator A: A1 . . . A6 |
| | strength >CRH from Operator A, Operator B, | Operator B: B1 . . . B4 |
| | Operator C etc for all local network operators. | Operator C: C1 . . . C3 |
| | Alternatively a predetermined maximum | (for example) |
| | number of BTSs (for instance four) may be | |
| | selected for each operator. | |
| 2 | For Operator A, choose BCH information from | SIMBTS emulates BTS |
| | BTS A1 and use this to configure SIMBTS | A1 |
| 3 | Receive Location Updates from Operator A | Produce list of identities |
| | MSs | |
| 4 | After either | Completion of emulation |
| | a) a preset time [t] or | of BTS and start emulation |
| | b) rate of MS Location Updates decreases to [n] | of new BTS |
| | LU per minute | |
| | choose BCH information from BTS A2 and use | |
| | this to configure SIMBTS | |
| 5 | Repeat steps 3 and 4 until all Operator A BTSs | Operator A emulation |
| | in list have been emulated | complete |
| 6 | Now switch to new operator (eg Operator B) | All BTSs from all |
| | and repeat steps 2 to 5 for Operator B, C . . . | Operators have been |
| | BTSs | emulated in area |

Thus, in summary the following sequence of steps is performed:
1. Obtain list of BTSs for Operator A
2. Obtain list of BTSs for Operator B
3. Obtain list of BTSs for Operator C
4. Emulate all BTSs in A list
5. Emulate all BTSs in B list
6. Emulate all BTSs in C list

Note that step 1 in Table 1 obtains BA lists from one BTS at a time. An enhanced technique for simultaneously obtaining BA lists from several BTSs takes step 1 in Table 1 and implements it simultaneously for several BTSs. These BTSs can be allocated as follows:
1 BA lists may be obtained by simultaneously interrogating Multiple BTSs for one Operator; or
2 BA lists may be obtained by simultaneously interrogating Multiple Operators; or
3 BA lists may be obtained by simultaneously interrogating Multiple Operators and Multiple BTSs per Operator.

Note that steps 2 to 5 in Table 1 are implemeneted for one BTS at a time. An enhanced technique for simultaneously emulating several BTSs takes steps 2 to 5 in Table 1 and implements them simultaneously for several BTSs. These BTSs can be allocated as follows:
1 Multiple BTSs for one Operator are simultaneously emulated; or
2 Multiple Operators are simultaneously emulated; or
3 Multiple Operators and Multiple BTSs per Operator are simultaneously emulated.

Simultaneous acquisition of BA lists, and simultaneous emulation require the SIMBTS to employ a multiband antenna 19 connected to multiband transmitter/receiver circuitry which can communicate simultaneously on multiple frequencies.

The allocation of BTSs to be emulated has to take into account conventional frequency planning considerations. This then governs how close the ARFCN spacing can be for simultaneous BTSs.

The advantage of simultaneous multiple emulation is that the identities of the local population of MSs can be acquired more quickly than with serial emulation. The factor of speed improvement is proportional to the number of BTSs emulated. Thus simultaneous emulation of four Operators will result in a factor of four speed improvement, all other conditions being equal.

An enhanced version of the process described above is to conditionally retain or reject mobiles as they register to the SIMBTS. The importance of this is that quickly rejecting mobiles, which are of no interest to the SIMBTS operator, back to their normal network operator minimises the impact for those mobiles. The SIMBTS is therefore of enhanced covertness due to the use of this technique. Specifically the MS user is very unlikely to notice that their phone is temporarily (for a few seconds) registering to the SIMBTS.

The detailed procedure is as follows:

TABLE 2
Detailed MS Accept or Reject

| Step | Action | Result |
|---|---|---|
| 1 | SIMBTS is set up to cause mobiles to be | |
| | attracted | |
| 2 | Mobile discovers SIMBTS | |
| 3 | MS evaluates C1/C2 and decides to perform | |
| | Location Update | |
| 4 | Mobile performs Location Update | |
| 5 | Mobile submits [Location Update Request] | |
| | message | |
| 6 | SIMBTS issues three identity challenges for | |
| | IMSI, IMEI and TMSI | |
| 7 | SIMBTS receives three identities | |
| 8 | SIMBTS decides whether to accept or reject | |
| | location update. Decision is dependent on | |
| | whether any of the three identities is a target | |
| 9 | SIMBTS issues Location Update Accept or | Mobile receives either |
| | Reject dependent on step 8 | LU-accept in which case it |
| | | camps on SIMBTS or |
| | | LU-reject in which case a |
| | | standard GSM rejection |
| | | message (such as “roaming |
| | | not allowed in this location |
| | | area”) is sent to the MS |
| | | which returns back to its |
| | | home network. |

The method above enables the SIMBTS 10 to acquire a list of IMSIs and IMEIs. These IMSI/IMEI pairs are recorded in a Main Database 17 shown in FIG. 2.

### SIM Tracking

A method is now described which tracks IMSI/IMEI pairings for a selected IMSI or IMEI. The tracking process is shown in FIG. 3. The pairings are recorded in a Family Database denoted 18 in FIG. 2. The structure of the Family Database is shown in FIG. 4, with direct associations between IDs indicated by double-headed arrows.

In step 30, an IMSI (denoted IMSI(0,1) in FIG. 4) or an IMEI (denoted IMEI (0,1) in FIG. 4)(0,1) is selected by a user of the SIMBTS 10. The nomenclature of FIG. 4 is as follows:
IMSI(x,y) denotes IMSI number y in generation x.
IMEI(x,y) denotes IMEI number y in generation x.

For instance, IMSI(0,1) may be selected by contacting an operator and getting the MSISDN to IMSI lookup from the HLR. The selected IMSI(0,1) or IMEI (0,1) is recorded in the Family Database 18. In the discussion below, we assume that IMSI(0,1) is selected.

In step 31, the IMSI(0,1) is used as a key to perform a historical search of the Main Database for IDs which are either directly or indirectly associated with the IMSI(0,1). Thus, if IMSI(0,1) is recorded in the Main Database, then all the IMEIs which are directly associated with IMSI(0,1) in the Main Database are recorded in the Family Database. The most recently recorded IMEI is denoted IMEI(0,1), and the other IMEIs are denoted IMEI(−1,1), IMEI(−1,2) etc. As well as searching for directly associated IMEIs (that is, IMEIs which have been used with the IMSI(0,1) in a previous communication), the historical search 31 also searches the Main Database for IDs indirectly associated with IMSI(0,1) (that is, not directly associated with IMSI(0,1), but associated via IMEI(−1,1) . . . IMEI(−1,n) or IMEI(0,1)). Thus it can be seen from FIG. 4 that the historical search builds a 0th generation (IMSI(0,1) and IMEI(0,1)) and a −1st generation (IMEI(−1,1). IMEI(−1,n), IMSI(−1,1). IMSI(−1,n). The historical search continues to propagate and construct further historical generations −2, −3 etc until no further associations are found.

In step 32, any associations are used to populate the Family Database 18. If the selected IMSI(0,1) has not previously been recorded in the Main Database, then the Historical Search returns a null result and no further data is recorded in the Family Database in step 32.

Running in parallel with the process of FIG. 3, the SIMBTS 10 continuously scrolls through the method described above in the section headed “IMSI/IMEI Acquisition”, updating the Main Database as it goes with IMEI/IMEI pairings. When a new IMSI/IMEI pair is detected, the IMSI/IMEI pair is stored in the Main Database in step 33. Note that a “new pair” is defined as either:
a pair in which neither the IMSI nor the IMEI have previously been recorded in the Main Database; or
a pair in which one of the IDs has been recorded in the Main Database, but not previously associated with the other ID in the pair; or
a pair in which both of the IDs have been recorded in the Main Database, but not previously associated with each other.

If an IMSI/IMEI pair is not new, then the date, time and location is recorded at step 37. Thus the Main Database builds up a record of all dates, times and locations when/where a particular IMEI/IMEI pair was detected.

At step 34 a check is made of whether either the IMSI or the IMEI in the new pair are recorded in the Family Database. If not, then neither is of interest, so the process returns to step 33 via step 37. The location data is typically input by a user in alphanumeric format via a keyboard (not shown) of the SIMBTS.

If one or both IDs are recorded in the Family Database, then at step 35 a check is made of whether the IDs represent a “new pair” for the Family Database 18 (using a similar definition of a “new pair”). If the pair is not new, then the process returns to step 33 via step 37. If the pair is new, then the process records the new pair in the Family Database in step 36, displays a “MULTIPLE IDENTITY ALERT” in step 40 on a display device (not shown) of the SIMBTS, and returns to step 31 after recording the date, time and location at step 38. At step 31 the process performs a historical search of the Main Database for whichever of the two IDs in the pair was “new” for the Family Database, and records any new associations in the Family Database in step 32.

Thus, after the 0th generation IDs (IMSI(0,1) and IMEI(0,1)) have been recorded, the next new IMSI is denoted IMSI(1,1) and the next new IMEI is denoted IMEI(1,1). These are denoted as 1^{st} generation IMSIs/IMEIs. As the process continues, a succession of generations may be built up, including the 2^{nd} generation, e^{th} generation and g^{th} generation shown in FIG. 4.

Thus it can be seen by FIG. 4 that the process records a network of generations of IMSIs and IMEIs, all associated directly or indirectly with a single selected IMSI(0,1). This gives an indication of all known occurrences of activity for a particular person during the time period of observation. Subsequently, the IMSIs in the Family Database 18 can be mapped to MSISDN numbers and lawful interception performed for a set of numbers that were not previously known. Alternatively, or in addition, the contents of the Family Database can be displayed on a display device (not shown) of the SIMBTS, or printed. The display or printout may simply be a list of IMSI/IMEI pairings, or may show a network of IMSI/IMEI pairings in the format illustrated in FIG. 4.

The process described above in FIGS. 3 and 4 envisages a situation in which the network of FIG. 4 is constructed initially (by performing a historical search) and then built up in real time as new IMSI/IMEI pairs are identified. Alternatively, the Family Database 18 may be omitted, and a search engine performs a “one-off” historical search (for instance in SQL) of the Main Database 17 to construct a network of the type illustrated in FIG. 5. In the case of FIG. 5 an IMSI has been used as the search key, and this IMSI has been associated with four IMEIs which in turn have each been associated with three other IMSIs. The network of FIG. 5 is displayed, and any of the circles can be clicked on by a user to display the associated IMSI or IMEI number. The links between an IMSI/IMEI pair can be clicked on to display the date, time and location of all occurrences of that pair.

1. A method of compiling a list of IDs associated with a mobile device user, the method including the steps of:
a) identifying and recording a first subscriber ID and a first device ID;
b) using one of the first IDs as a key to identify one or more second IDs, each of which has been associated with the key in a mobile device communication; a
c) recording the second ID(s);
d) using one of the second IDs as a key to identify one or more third IDs, each of which has been associated with the second ID in a mobile device communication; and
e) recording the third TD(s).

2. (canceled)

3. A method according to claim 1, further comprising displaying the first IDs and/or the second ID(s).

4. A method according to claim 1, further comprising displaying a network of subscriber IDs and device IDs, the network including links indicative of associations between the IDs.

5. A method of tracking a user comprising compiling a list of IDs by a method according to claim 1; and
monitoring for the reception of any of the recorded device IDs or subscriber IDs.

6. A search engine configured to:
a) use a first subscriber ID or a first device ID as a key to identify one or more second IDs, each of which has been associated with the key in a mobile device communication; and
b) record the second ID(s);
c) use one of the second IDs as a key to identify one or more third IDs, each of which has been associated with the second ID in a mobile device communication; and
d) record the third ID(s).

7. Apparatus for compiling a list of IDs associated with a mobile device users the apparatus including:
a) a storage device for recording a first subscriber ID and a first device ID; and
b) a processor configured to use one of the first IDs as a key to identify one or more second IDs, each of which has been associated with the key in a mobile device communication, and further configured to use one of the second ID as a key to identify one or more third IDs, each of which has been associated with the second ID in a mobile device communication.
